(19) United States
(12) Patent Application Publication
(10) Pub. No.: US 2010/0302546 A1
(43) Pub. Date: Dec. 2, 2010

(54) OPTICAL MEASUREMENT OF SAMPLES

(76) Inventors: Masud Azimi, Belmont, MA (US); Arran Bibby, Savannah, GA (US); Christopher Brown, Haverhill, MA (US); Kevin J. Knopp, Newburyport, MA (US); Daryoosh Vakhshoori, Cambridge, MA (US)

Correspondence Address: FISH & RICHARDSON PC, P.O. BOX 1022, MINNEAPOLIS, MN, 55440-1022, US

(21) Appl. No.: 12/472,861

(22) Filed: May 27, 2009

(51) Int. Cl. G01N 21/00; G01J 1/10

(52) U.S. Cl. 356/437; 356/243.1

(57) ABSTRACT

A portable device includes a base unit, an extension, and a mirror. The base unit includes a light source, a light detector, and at least one window through which light exits from, and is received by, the base unit. The extension is configured, during use, to be attached to the base unit and to extend from the at least one window, in a direction away from the base unit, the extension defining at least a portion of a sample volume in fluid communication with gases substantially surrounding one or more of the extension and the base unit. The mirror is attached to the extension at a distance from the at least one window. An optical path is defined between the mirror and the at least one window such that light from the light source moves through the sample volume along the optical path, and the mirror is aligned to reflect the light back to the at least one window for detection by the light detector.

### TECHNICAL FIELD

This disclosure relates to optical measurement and identification of samples.

### BACKGROUND

Optical measurement devices can be used by security personnel to identify unknown substances that may potentially pose a threat to public safety. For example, infrared light can be used to interrogate and identify the unknown substances.

### SUMMARY

A portable device provides identification and/or quantification of gas substantially surrounding at least a portion of the portable device.

In one aspect, a portable device includes a base unit, an extension, and a mirror. The base unit includes a light source, a light detector, and at least one window through which light exits from, and is received by, the base unit. The extension is configured, during use, to be attached to the base unit and to extend from the at least one window, in a direction away from the base unit, the extension defining at least a portion of a sample volume in fluid communication with gases substantially surrounding one or more of the extension and the base unit. The mirror is attached to the extension at a distance from the at least one window. An optical path is defined between the mirror and the at least one window such that light from the light source moves through the sample volume along the optical path, and the mirror is aligned to reflect the light back to the at least one window for detection by the light detector.

In some embodiments, the base unit and the extension are positionable in fluid communication with gases substantially surrounding the extension and the base unit during measurement of the gases.

In some embodiments, the distance between the mirror and the at least one window is less than 50 cm.

In some embodiments, the light from the light source includes infrared light.

In some embodiments, the base unit is a component of a Fourier transform infrared spectrometer for gases along the optical path.

In some embodiments, the base unit has a handheld form factor.

In some embodiments, the window is partially reflective to define an optical cavity between the window and the mirror so that the light from the light source is reflected along the optical path multiple times.

In some embodiments, the extension includes one or more walls. At least one of the walls defines one or more openings. The gases substantially surrounding one or more of the extension and the base unit are in fluid communication with the sample volume through the one or more openings.

In some embodiments, the extension includes one or more gas permeable membranes. At least some gases substantially surrounding one or more of the extension and base unit are in fluid communication with the sample volume through the one or more gas permeable membranes.

In some embodiments, the portable device includes an electronic processor in communication with the light detector. The electronic processor is configured to determine information about gases in the sample volume based at least in part on the measurements made by the light detector. The electronic processor can be coupled to the light detector in the base unit. The information determined by the electronic processor can include an identification of one or more constituents of the gases in the sample volume. The information determined by the electronic processor can include a verification of an identity of one or more constituents of the gases in the interior volume. The electronic processor can be further configured to store reference data and to compare the stored reference data to the information determined by the electronic processor.

In some embodiments, the base unit further includes a user interface for presenting information determined from measurements by the light detector to a user.

In some embodiments, the portable device further includes circuitry for wirelessly transmitting information determined from measurements by the light detector to a remote location.

In some embodiments, the portable device weighs less than 2 kg.

In some embodiments, gas pressure in the sample volume is substantially equal to the gas pressure of the gases substantially surrounding one or more of the extension and the base unit.

In some embodiments, the distance between the mirror and the at least one window is adjustable to change a length of the optical path in the sample volume.

In some embodiments, the portable device further includes an electronic processor and a user interface. The electronic processor is in communication with each of the light detector and the user interface, the electronic processor configured to send to the user interface an indication of a signal-to-noise ratio of a signal measured and the noise detected at the light detector.

In some embodiments, the extension is releasably attachable to the base unit. The base unit can be configured to support focusing optics along an optical path between the light source and the sample volume such that the focusing optics direct light into the sample volume and direct reflected light from the sample volume toward the light detector. The base unit can be further configured to support releasably a prism, interchangeably with the focusing optics, such that a surface of the prism contacts a solid or a liquid sample while the prism is coupled to the base unit.

In some embodiments, the light source and the light detector are substantially sealed from fluid communication with the sample volume.

In some embodiments, the extension includes a material selected from anodized aluminum, coated metal, stainless steel, and plastic.

In some embodiments, a combined length of the extension attached to the base unit is less than about 50 cm.

In some embodiments, the extension is integrally formed with the base unit.

In some embodiments, the extension is hollow.

In some embodiments, the base unit is portable.

In some embodiments, the portable device further includes electronic circuitry configured to determine a quantity of light absorbed by at least one optical element along the optical path and by clean air occupying the sample volume, store one or more calibration parameters based at least in part on the determined quantity of light, receive a measurement of light absorbed by the gases in fluid communication with at least a portion of the sample volume, and construct a signal indicative of the gases in fluid communication with at least a portion of the sample volume by adjusting the received measurement of light by the one or more calibration parameters. The electronic circuitry can be further configured to determine whether features of a beam reflected through clean air occupying at least a portion of the sample volume can be accounted for by the quantity of light absorbed by at least one optical element in a portable apparatus and by clean air in a sample volume of the portable apparatus. The electronic circuitry can be further configured to send an indication of calibration to a user interface. The indication can be based at least in part on the determination of whether features of the beam reflected through clean air occupying at least a portion of the sample volume can be accounted for by the quantity of light absorbed by at least one optical element in a portable apparatus and by clean air in a sample volume of the portable apparatus.

In another aspect, a method includes positioning a portable apparatus to expose a sample volume of the portable apparatus to gases substantially surrounding the portable apparatus and measuring the light after at least one pass along an optical path to determine information about the gases. The sample volume is in fluid communication with the gases substantially surrounding the portable apparatus. The portable apparatus includes a light source and a mirror arranged relative to one another to define the optical path, through the sample volume, for light produced by the light source.

In some embodiments, gas pressure in the sample volume is substantially equal to the gas pressure of the gases substantially surrounding the portable device.

In some embodiments, the sample volume is exposed to gases in a headspace of a container.

In some embodiments, the container includes solid or liquid material that produces a vapor pressure in the headspace of the container.

In some embodiments, determining information about the gases includes identifying one or more constituents of the gases in the sample volume.

In some embodiments, the method further includes comparing the information determined about the gases to reference data stored by the portable device. The method can further include verifying the identity of one or more constituents of the gases in the sample volume. The verification can be based at least in part on a comparison between the reference data and the determined information. The method can further include sending an alarm to a user interface of the portable device based at least in part on the verification.

In some embodiments, the method further includes detecting saturation of a sensor based at least in part on the measurement of the light.

In some embodiments, the method further includes sending instructions to a user to move the portable apparatus during the measurement of the light.

In some embodiments, the method further includes determining a quantity of light absorbed by at least one optical element in a portable apparatus and by clean air in a sample volume of the portable apparatus, storing one or more calibration parameters based at least in part on each determined quantity of light, placing the portable apparatus into the gases such that the gases occupy at least a portion of the sample volume, receiving a measurement of light absorbed by the gases occupying at least a portion of the sample volume, and constructing a signal indicative of the gases occupying at least a portion of the sample volume by adjusting the received measurement of light by the one or more calibration parameters. The method can further include determining whether features of a beam reflected through clean air occupying at least a portion of the sample volume can be accounted for by the quantity of light absorbed by at least one optical element in a portable apparatus and by clean air in a sample volume of the portable apparatus. The method can further include sending an indication of calibration to a user interface. The indication can be based at least in part on the determination of whether features of the beam reflected through clean air occupying at least a portion of the sample volume can be accounted for by the quantity of light absorbed by at least one optical element in a portable apparatus and by clean air in a sample volume of the portable apparatus.

Embodiments can include one or more of the following advantages.

In some embodiments, the extension (e.g., a gas tower) defines at least a portion of a sample volume, the extension is attachable to the base unit such that the sample volume is positionable in fluid communication with gases (e.g., a single gas and/or a multiple component gas mixture, each alternatively referred to herein as a gas) substantially surrounding the extension and/or the base unit during measurement of the gases. For example, the extension can define one or more apertures extending through a sidewall of the extension to allow gas outside of the extension to move into the sample volume during use of the measurement device. Such fluid communication between the sample volume and gas outside of the extension can allow the gases to pass into the sample volume without the use of an internal or external mechanical and/or thermal gas moving device. For example, gases can pass into the sample volume through diffusion, natural convection, or through manually produced forced convection (e.g., as produced by moving the measurement device through the gases). This can reduce the need for certain complex and potentially costly mechanisms, such as a vacuum and/or pump mechanism, to draw gases into the sample volume. Additionally or alternatively, the ability to position the sample volume in fluid communication with gases substantially surrounding the extension and/or the base unit during measurement of the gases can improve the accuracy of measurements made by the portable device by, for example, facilitating placement of the portable device closer to the source of the gases being measured. The ability to position the sample volume in fluid communication with gases substantially surrounding the extension and/or the base unit during measurement of the gases can, additionally or alternatively, reduce the amount of setup required for obtaining a measurement of gases. For example, in some instances, the portable device can be used to make measurements while being moved (e.g., carried) by an operator during a sweep of an area.

In some embodiments, the base unit releasably supports the extension in a fixed position during operation of the measurement device to define an optical path for light received from and reflected toward the base unit. Such releasable support of the extension can allow the extension to be decoupled from the base unit (e.g., without the use of tools) between measurements. By removing the extension from the base unit, a system operator can store the extension to facilitate transport of the measurement device. Additionally or alternatively, the removable extension can allow the system operator to configure the measurement device as necessary in the field. For example, the measurement device can include a set of extensions, each having a different optical path length. During use, a system operator can select an extension with an optical path length that will facilitate the most accurate measurement of a gas sample. For example, the system operator can select an extension having a shorter optical path length to reduce the likelihood of saturation of the light detector carried by the base unit. Additionally or alternatively, the removable extension can be interchangeable with an extension including an attenuated total reflectance (ATR) element (e.g., a prism) and configured for optical measurement of solid and/or liquid samples of interest.

In some embodiments, the base unit includes a handheld Fourier transform infrared (FTIR) scanner. Such a scanner is robust, with the capability of identifying a range of gases and/or with the capability of being updated to identify a particular set of gases. Additionally or alternatively, such an FTIR scanner can be relatively simple to operate, so that system operators with relatively limited training are capable of successfully using the devices to analyze the chemical composition of one or more substances of interest.

In certain embodiments, the measurement devices can be reliably and repeatably used in a variety of environments, including uncontrolled environments. For example, the measurement devices can be configured to identify samples with a relatively high degree of certainty.

Unless otherwise defined, all technical and scientific terms used herein have the same meaning as commonly understood by one of ordinary skill in the art. Although methods and materials similar or equivalent to those described herein can be used in the practice or testing of the disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As used herein, the term “gas” includes one or more substances in the gaseous state as well as diffused matter (e.g., solid particles and/or liquid droplets) substantially suspended in the one or more substances in the gaseous state.

As used herein the term “light” refers to electromagnetic radiation in the infrared, near infrared, visible light, and ultraviolet frequency ranges.

As used herein, the term “clean air” refers to air that is substantially free of solid, liquid, and gaseous pollutants as well as other foreign matter such that the constituent gases of the air (including water vapor) are present in volumetric proportions substantially equal to those typically found in the Earth's atmosphere.

Other aspects, features, and advantages will be apparent from the description and drawings, and from the claims.

### DESCRIPTION OF DRAWINGS

FIG. 1A is a schematic diagram of an embodiment of a measurement device with a portion of the measurement device disposed in the headspace of a container to measure the chemical composition of gas in the headspace.

FIG. 1B is a schematic diagram of an embodiment of the measurement device shown in FIG. 1A disposed in the headspace of a container to measure the chemical composition of gas in the headspace.

FIG. 2 is a partially exploded, isometric view of the measurement device shown in FIGS. 1A-B, with a partial cut-away view of the gas tower shown in FIGS. 1A-B.

FIG. 3 is a cross-sectional view of the measurement device of FIG. 2, taken along line 3-3 in FIG. 2.

FIG. 4A is a flow chart of processes used in the measurement device of FIG. 1.

FIG. 4B is a flow chart of processes used in the measurement device of FIGS. 1A-B.

FIG. 5 is a flow chart of processes used in the measurement device of FIGS. 1A-B.

FIG. 6 is a cross-sectional view of an embodiment of a gas tower.

FIG. 7 is a cross-sectional view of an embodiment of a gas tower.

FIG. 8 is a cross-sectional view of an embodiment of a gas tower.

FIG. 9 is an isometric view of an embodiment of a measurement device.

### DETAILED DESCRIPTION

Many applications exist for portable measurement devices, including field identification of unknown substances by law enforcement and security personnel, detection of prohibited substances at airports and in other secure and/or public locations, and identification of pharmaceutical agents, industrial chemicals, explosives, energetic materials, and other agents. To be useful in a variety of situations, it can be advantageous for portable measurement devices to have a handheld form factor, to provide rapid and accurate results, and to be reconfigurable for measurement of different types of samples in the field.

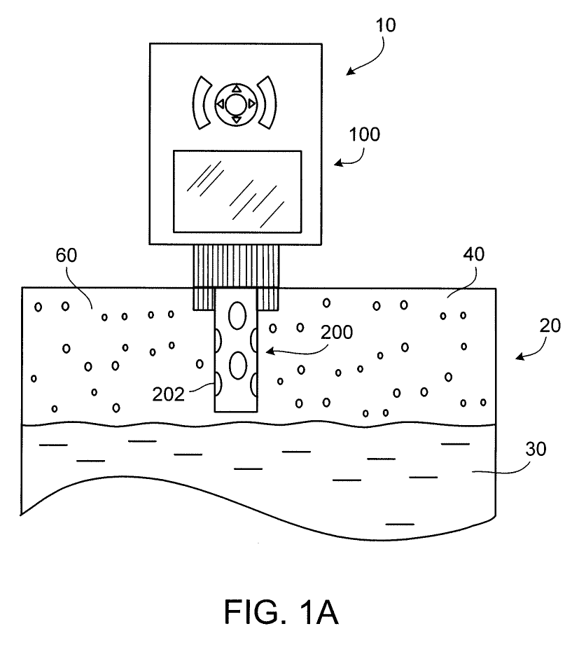

Referring to FIG. 1A, a measurement device 10 includes a base unit 100 and a tower 200 (e.g., an extension) attachable to the base unit 100 and extending in a direction substantially away from the base unit 100. In the exemplary use shown in the figure, a container 20 contains a liquid 30 and defines a headspace 40 in the volume between the top level of liquid 30 and the container 20. The headspace 40 is occupied by a gas 60 formed from evaporation of a portion of the liquid 30. The measurement device 10 is positioned adjacent to a top portion of the container 20 to allow the tower 200 to extend into the headspace 40 such that the tower 200 is in fluid communication with the gas 60. As described below, at least some of the gas 60 can pass into the tower 200. As also described below, the base unit 100 emits light into the gas 60 in the tower 200 and receives reflected light from the tower 200.

The base unit 100 processes the received light as part of an optical analysis (e.g., FTIR analysis) of the gas 60. The base unit 100 can compare the results of this optical analysis to a database stored in the base unit 100 to identify the gas 60 in the headspace 40. Such identification can facilitate determination of whether the contents of the container 20 are authentic and/or of a specified quality. Additionally or alternatively, the base unit 100 can compare the sample of interest to a list of prohibited substances—which can also be stored in the base unit 100—to determine whether particular precautions should be taken in handling the substance, and/or whether additional actions by security personnel, for example, are warranted.

Referring to FIG. 1B, the entire measurement device 10 can be placed into a measurement environment, such as the headspace 40, such that the gas 60 in the measurement environment substantially surrounds the base unit 100 and the tower 200. The ability to place the entire measurement device 10 into a measurement environment to be substantially surrounded by the gas 60 in the measurement environment can allow the tower 200 to be placed closer to the source of the gas 60 which can improve the accuracy of measurements made by the measurement device 10. Additionally or alternatively, the ability to place the entire measurement device 10 into a measurement environment can reduce the amount of setup required to obtain a measurement of the gas 60.

The base unit 100 includes an optical assembly, as described below, that includes lightweight components mounted to resist mechanical vibration. Such an ability to resist mechanical vibration and/or other stresses that could interfere with an optical measurement, can facilitate movement of the measurement device 10 while the measurement device 10 is performing an optical measurement of the gas 60. Such movement of the measurement device 10 can allow, for example, an operator to perform a detection sweep of an area by moving the measurement device 10 through the area to determine whether potentially hazardous gas is present in the area.

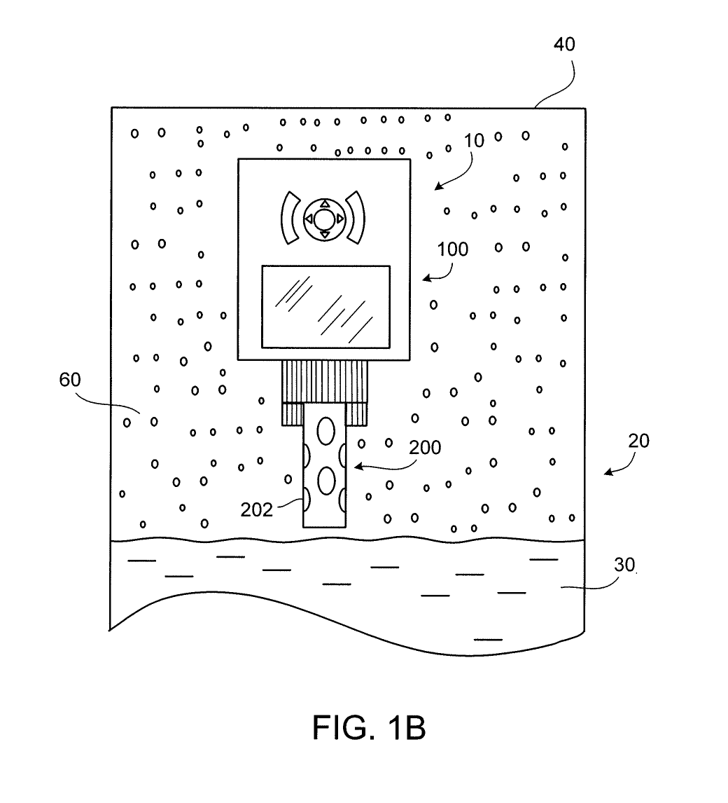

Referring to FIG. 2, the tower 200 includes a collar 204, an extension 206, and a reflector 210 (e.g., a mirror). The extension 206 has a first end portion 216 and a second end portion 218 and defines a sample volume 228 extending therebetween. The extension 206 supports the reflector 210 in a substantially fixed position along the first end portion 216 such that the reflector 210 can reflect light to and from the sample volume. The collar 204 is coupled to the second end portion 218 of the extension 206 and is concentrically disposed about an outer diameter of the extension 206 to secure and align the extension 206 relative to the base unit 100 such that light can pass between the base unit 100 and the tower 200 during optical analysis of a gas in the sample volume 228.

The extension 206 defines one or more apertures 202 open to the environment such that the sample volume 228 is in fluid communication with gas at the exterior of the extension 206. The sample volume 228 is at substantially the same pressure as the gas at the exterior of the extension 206 to allow the gas to pass into the sample volume 228. For example, through this configuration, the gas can pass into the sample volume 228 through diffusion, natural convection, and/or forced convection created by moving the measurement device 10. Thus, this configuration can facilitate formation of the measurement device 10 with a handheld form factor by reducing the need for a gas pumping mechanism, which can be complex and bulky.

The apertures 202 can be arranged along the extension 206, from the first end portion 216 to the second end portion 218. Additionally or alternatively, the apertures 202 can be arranged about a circumference of the extension 206. In some embodiments, the open area defined by the apertures is over 50% of the total surface area of the extension 206. Such an open area can facilitate passage of gas into the sample volume 228 with minimal pressure differential between the sample volume 228 and the exterior of the extension 206.

The extension 206 is formed of hard-anodized aluminum, over-coated with Teflon to reduce the likelihood that the extension 206 will corrode through exposure to chemicals (such as exposure that occurs by inserting the tower 200 into the headspace 40). For example, this material resists corrosion when exposed to droplets of a 37% concentration of hydrochloric acid for an hour. In certain embodiments, at least a portion of the extension 306 has a hard anodized aluminum coating.

The reflector 210 has at least one polished metal surface to allow the reflector 210 to receive light sent into the sample volume 228 by the base unit 100 and to reflect a substantial amount (e.g., all) of the received light back through the sample volume 228, toward the base unit 100. The polished metal can be one or more of the following: gold, silver, copper, nickel aluminum, and/or stainless steel. In some embodiments, the polished metal is a coating deposited onto a substrate (e.g., glass). In certain embodiments, the reflector 210 is metal all the way through, with a polished surface.

A protective coating can be formed on top of the polished metal surface to protect the polished metal surface, for example, from scratching and/or corrosion. The protective coating can be a diamond-layer coating. Additionally or alternatively, the protective coating can include a hard dielectric material.

The reflector 210 is supported by the first end 216 of the extension 206 such that surfaces (e.g., non-reflective surfaces) of the reflector 210 are substantially surrounded by the extension 206 to reduce, for example, the likelihood that the reflector 210 will become dislodged upon experiencing shock and vibration associated with normal use. The reflector 210 can be supported by the by the first end 216 of the extension 206 such that the reflector 210 is accessible for cleaning from outside of the tower 200 while the tower 200 is coupled to the base unit 100. Additionally or alternatively, the reflector 210 can be releasably coupled to the extension 206 such that the reflector 210 can be removed from the extension 206 for cleaning and/or replacement.

The collar 204 is supported, in a fixed position, by the second end 218 of the extension 206 and includes one or more ribs 230 that can assist the user in gripping the collar 204 while mounting and/or dismounting the tower 200 to/from the base 100. The collar 204 defines a substantially tubular volume, open on each end to allow light from the base unit 100 to pass to the sample volume 228 during operation of the measurement device 10. The inner portion of the collar 204 is threaded for engagement with the base unit 100, as described below.

The base unit 100 includes an optical assembly 128 and an enclosure 156 having a top portion 156a and a bottom portion 156b. The top portion that couples (e.g., releasably couples) to a bottom portion 156b to form a substantially enclosed volume that carries the optical assembly 128 as described below.

The enclosure 156 is sized to have a handheld form factor. For example, the enclosure can be a substantially rectangular box having a major dimension in a direction extending substantially parallel to the tower 200 when the tower 200 is attached to the base unit 100. This orientation can allow a user to grasp the enclosure 156 along the minor dimension of the rectangular box to point the tower 200 in a desired direction (e.g., toward a gas to be measured).

The enclosure 156 is formed from a hard, lightweight, durable material such as a hard plastic. In certain embodiments, the enclosure 156 can be formed from materials such as aluminum, acrylonitrile butadiene styrene (ABS) plastic, polycarbonate, and other engineering resin plastics with relatively high impact resistance.

The top portion 156a of the enclosure 156 includes a user interface 232 that typically includes an input portion (e.g., buttons) and an output portion (e.g., a visual display and/or audio alarm). The user interface 232 can be used to provide the user with an indication of the presence of a hazardous material. Additionally or alternatively, the user interface 232 can accept inputs related to initiating a measurement to be performed by the measurement device 10.

The bottom portion 156b of the enclosure 156 includes a protrusion 158 for releasbly coupling to the tower 200. The protrusion 158 includes a substantially tubular connector portion 160 supporting a window 166. The outer diameter of the connector portion 160 is approximately equal to the inner diameter of the collar 218 such that the collar 218 can be placed over the connector portion 160. The outer circumference of the connector portion 160 is threaded to engage with mating threads formed on an interior surface of the collar 218 such that collar 218 is placed over the connector portion 160 and screwed onto the connector portion 160.

The window 166 is supported in the connector portion 160 such that the window can direct light out of the base unit 100 and into the tower 200 while receiving light into the base unit 100 from the tower 200. The window 166 forms a substantially fluid tight seal with the connector portion 166 such that gas and/or foreign matter from the tower 200 is unlikely to permeate into the base unit 100 through the connector portion 160. The window 166 is recessed from the end of the connector portion 160 that mates with the collar 218 of the tower 200. Such a recessed configuration can reduce the likelihood that the window will become damaged (e.g., scratched) during mounting and dismounting of the tower 200.

The window 166 can be made of a material that is substantially transparent (e.g., low absorbance and/or low scattering) to the wavelength of the light emitted from the optical assembly 128. For example, the window 166 can be made of ZnS, ZnSe, germanium, diamond, and/or CLEARTRAN™ available from Rohm and Haas, Philadelphia, Pa.

The window 166 can include one or more coatings to improve the optical performance of the window and/or to protect the window 166 from damage. For example, one or more surfaces of the window 166 can be coated with an anti-reflective coating to reduce the amount of light dissipated as light (e.g., light entering or exiting the base unit 100) comes into contact with the window 166. Additionally or alternatively, one or more surfaces of the window 166 can include a diamond-like coating (DLC) that can protect the window 166 from damage (e.g., scratching) during use. The DLC can be applied to the window 166 through any of various different methods including, for example, plasma coating, chemical vapor deposition, magnetron sputtering, and/or ion-beam sputtering.

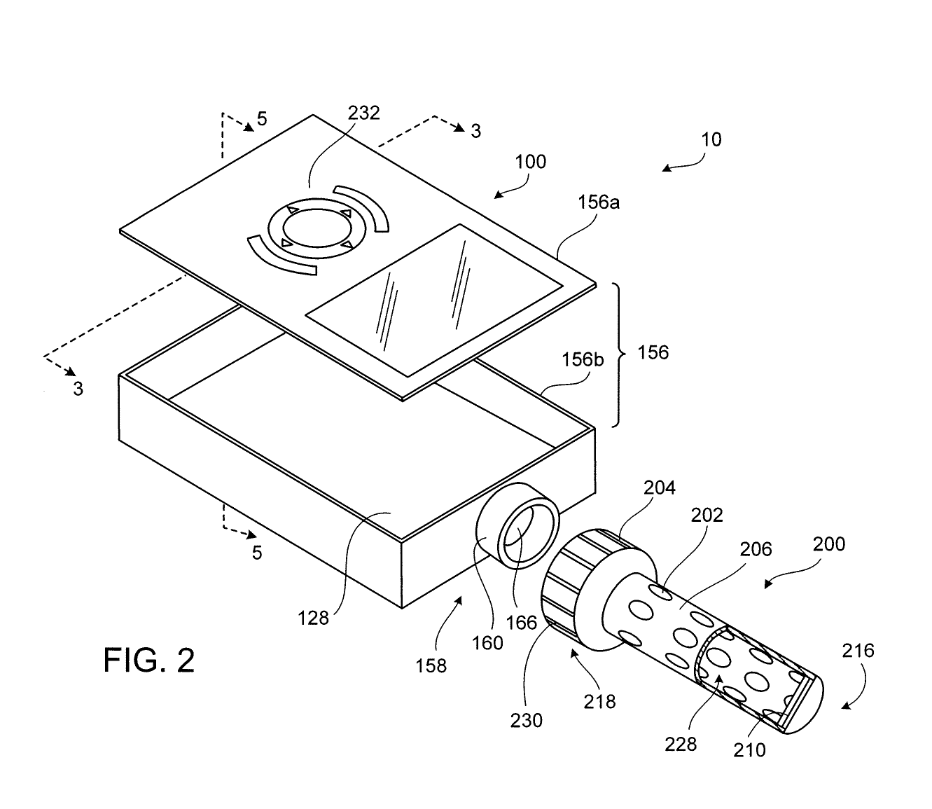

Referring to FIG. 3, the enclosure 156 can have a length, d, of greater than about 5 cm and/or less than about 100 cm (e.g., about 50 cm or less). Additionally or alternatively, the total length of the measurement device 10 (e.g., the length of the base unit 100 plus the length of the tower 200 as attached to the base unit 100) can be greater than about 5 cm and/or less than about 100 cm (e.g., about 50 cm or less). Lengths in these ranges can facilitate portability of the measurement device 10 and, in some embodiments, facilitates manual manipulation (e.g., handheld operation) of the measurement device 10 during use in the field.

The optical assembly 128 carried within the enclosure 156 includes: light sources 102 and 144; mirrors 104, 108, 110, 130, and 148; beamsplitters 106 and 146; and detectors 132 and 150. The optical assembly 128 also includes a shaft 112, a bushing 114, and an actuator 116 coupled to the mirror 110, and an electronic processor 134, an electronic display connector 136 (e.g., for connection to the user interface 232 disposed along a surface of the top surface of the enclosure 156a), an input device connector 138 (e.g. for connection to the user interface 232), a storage unit 140, and a communication interface 142 for transmitting/receiving signals to/from the base unit 100. The electronic processor 134 is in electrical communication with the detector 132, the storage unit 140, the communication interface 142, the display 136 connector, the input device 138 connector, the light sources 102 and 144, the detector 150, and the actuator 116, respectively, via communication lines 162a-i.

The base unit 100 is configured for use as a Fourier transform infrared (FTIR) spectrometer. During operation, light 168 is generated by the light source 102 under the control of the processor 134. The light 168 is directed by mirror 104 to be incident on beamsplitter 106, which is formed from a beamsplitting optical element 106a and a phase compensating plate 106b, and which divides the light 168 into two beams. A first beam 170 reflects from a surface of beamsplitter 106, propagates along a beam path which is parallel to arrow 171, and is incident on the fixed mirror 108. The fixed mirror 108 reflects the first beam 170 so that the first beam 170 propagates along the same beam path, but in an opposite direction (e.g., towards beamsplitter 106).

A second beam 172 is transmitted through the beamsplitter 106 and propagates along a beam path which is parallel to the arrow 173. The second beam 172 is incident on a first surface 110a of movable mirror 110. The movable mirror 110 reflects the second beam 172 so that the beam 172 propagates along the same beam path, but in an opposite direction (e.g., towards the beamsplitter 106).

The first and second beams 170 and 172 are combined by the beamsplitter 106, which spatially overlaps the beams to form an incident light beam 174. The mirrors 118 and 120 direct the incident light beam 174, through a window 188, to enter focusing optics 198 disposed in the connector portion 160. In general, the focusing optics 198 transmit light from the optical assembly 128 toward the reflector 210 and direct reflected light from the reflector 210 toward the optical assembly 128 for processing.

The focusing optics 198 include a prism 186 and reflectors 212, 214. The reflector 214 redirects the incident light beam 174 toward the prism 186. The prism 186 redirects the incident light beam 174 through the window 166 and into the sample volume 228. Within the sample volume 228 the incident light beam 174 interacts with gas (not shown) that has diffused into the sample volume 228 via apertures 202. Typically, the gas in the sample volume 228 absorbs a portion of the light in the light beam 174. The light beam 174 continues through the sample volume 228 and strikes the mirror 210 supported along the first end portion 216 of the extension 206. The light beam 174 reflects from the mirror 210 as reflected beam 176.

The reflected beam 176 returns through the sample volume 228 and enters the base unit 100 through the window 166. The reflected beam 176 strikes the prism 186 such that the reflected beam 176 is redirected toward the reflector 214. The reflector 214 directs the reflected beam 176 into the optical assembly 128 via a window 192.

Within the optical assembly, the reflected beam 176 is directed by mirror 130 to be incident on the detector 132. Under the control of the processor 134, the detector 132 measures one or more properties of the reflected light in the reflected beam 176. For example, the detector 132 can determine absorption information about the gas in the sample volume 228 based on measurements of reflected beam 176.

Typically, the light in reflected beam 176 is measured at a plurality of positions of the movable mirror 110. The mirrors 108 and 110, together with the beamsplitter 106, are arranged to form a Michelson interferometer, and by translating the mirror 110 in a direction parallel to arrow the 164 prior to each measurement of the reflected light 176, the plurality of measurements of the light in the reflected beam 176 form an interferogram. The interferogram includes information such as sample absorption information. The processor 134 can be configured to apply one or more mathematical transformations to the interferogram to obtain the sample absorption information. For example, the processor 134 can be configured to transform the interferogram measurements from a first domain (such as time or a spatial dimension) to a second domain (such as frequency) that is conjugate to the first domain. The transform(s) that is/are applied to the data can include a Fourier transform, for example.

The movable mirror 110 is coupled to the shaft 112, the bushing 114, and the actuator 116. The shaft 112 moves freely within the bushing 114, and a viscous fluid is disposed between the shaft 112 and the bushing 114 to permit relative motion between the two. The mirror 110 moves when the actuator 116 receives control signals from the processor 134 via the communication line 162i. The actuator 116 initiates movement of the shaft 112 in a direction parallel to the arrow 164, and the mirror 110 moves in concert with the shaft 112. The bushing 114 provides support for the shaft 112, preventing wobble of the shaft 112 during translation. However, the bushing 114 and the shaft 112 are effectively mechanically decoupled from one another by the fluid disposed between them; mechanical disturbances such as vibrations are coupled poorly between the shaft 112 and the bushing 114. Additionally or alternatively, the components of the optical assembly are lightweight to reduce the need for precise movement while an interferogram is being obtained. For at least these reasons, the alignment of the Michelson interferometer remains relatively undisturbed and remains relatively robust even when mechanical perturbations such as vibrations are present in other portions of the measurement device 10. Such a relative resistance to mechanical perturbations can facilitate movement of the measurement device 10 while an optical measurement of the gas 60 in the sample volume 228 is being obtained. The ability to move the measurement device 10 during a measurement can facilitate rapid and accurate measurement sweeps of an area (e.g., such as could be performed by an operator carrying the measurement device 10 through an area suspected of containing potentially hazardous gas). In some embodiments, the portability of the measurement device 10 during a measurement can be further improved through the use of a vibration-damping coating disposed substantially between the optical assembly 128 and the enclosure 156.

To measure the position of the mirror 110, the optical assembly 128 includes a second interferometer assembly that includes the light source 144, the beamsplitter 146, the mirror 148, and the detector 150. These components are arranged to form a Michelson interferometer. During a mirror position measurement operation, light source 144 receives a control signal from the processor 134 via the communication line 162g, and generates a light beam 178. The beam 178 is incident on the beamsplitter 146, which separates the light beam 178 into a first beam 180 and a second beam 182. The first beam 180 reflects from the surface of the beamsplitter 146 and is incident on a second surface 110b of mirror 110. The second surface 110b is positioned opposite the first surface 110a of the mirror 110. The first beam 180 reflects from the surface 110b and returns to the beamsplitter 146.

The second beam 182 is transmitted through the beamsplitter 146, reflected by the mirror 148, and returned to the beamsplitter 146. The beamsplitter 146 combines (e.g., spatially overlaps) the reflected beams 180 and 182, and the combined beam 184 is directed to the detector 150. The detector 150 receives control signals from the processor 134 via communication line 162h, and is configured to measure an intensity of the combined beam 184. As the position of the mirror 110 changes (e.g., due to translation of mirror 110 along a direction parallel to the arrow 164), the intensity of the light measured by the detector 150 changes due to interference between the first beam 180 and the second beam 182 in the combined beam 184. By analyzing the changes in measured light intensity from the detector 150, the processor 134 can determine with high accuracy the position of the mirror 110.

The processor 134 combines the position information for the mirror 110 with measurements of the light in the reflected beam 176 to construct an interferogram for the gas in the sample volume 228. As discussed above, the processor 134 can be configured to apply a Fourier transform to the interferogram to obtain absorption information about the gas in the sample volume 228 from the interferogram. The processor 134 can compare the absorption information to reference information (e.g., reference absorption information) stored in the storage unit 140 to determine an identity of the gas in the sample volume 228. For example, the processor 134 can determine whether the absorption information for the gas matches any one or more of a plurality of sets of reference absorption information for a variety of substances that are stored as database records in the storage unit 140. If a match is found (e.g., the gas absorption information and the reference information for a particular substance agree sufficiently), then the gas in the sample volume 228 is considered to be identified by the processor 134. The processor 134 can send an electronic signal to the user interface 232 that indicates to a system operator that identification of the gas in the sample volume 228 was successful, and provides the name of the identified gas. The signal can also indicate to the system operator how closely the sample absorption information and the reference information agree. For example, numeric values of one or more metrics can be provided which indicate the extent of correspondence between the sample absorption information and the reference information on a numerical scale.

If a match between the sample absorption information and the reference information is not found by the processor 134, the processor can send an electronic signal to the user interface 232 that indicates to the system operator that the gas in the sample volume 228 was not successfully identified. The electronic signal can include, in some embodiments, a prompt to the system operator to repeat the sample absorption measurements.

Reference information stored in the storage unit 140 can include reference absorption information for a variety of different substances. The reference information can also include one or more lists of prohibited substances. Lists of prohibited substances can include, for example, substances that are not permitted beyond a checkpoint (e.g., beyond a factory gate). Lists of prohibited substances can also include, for example, substances that are not permitted in various public locations such as government buildings for security and public safety reasons. If identification of gas in the sample volume 228 is successful, the processor 134 can compare the identity of the gas against one or more lists of prohibited substances stored in storage unit 140. If the gas appears on a list as a prohibited substance, the processor 134 can alert the system operator that a prohibited substance has been detected. The alert can include a warning message displayed on the user interface 232 and/or a colored display (e.g., a flashing red warning) on the user interface 232. The processor 134 can also sound an audio alarm via the user interface 232.

The storage unit 140 typically includes a re-writable persistent flash memory module. The memory module of the storage unit 140 is removable from the enclosure 156 (e.g., through a USB connection that mates with a USB port defined by the storage unit 140) for updating information stored in the memory module. The memory module is configured to store a database that includes a library of infrared absorption information about various substances. The processor 134 can retrieve reference absorption information from the storage unit 140. The storage unit 140 can also store device settings and/or other configuration information such as default operating parameters. Other storage media can also be included in storage unit 140, including various types of re-writable and non-rewritable magnetic media, optical media, and electronic memory.

The communication interface 142 can receive and transmit signals from/to the processor 134. The communication interface 142 includes a wireless transmitter/receiver unit that is configured to transmit signals from the processor 134 to other devices, and to receive signals from other devices and to communicate the received signals to the processor 134. Details of wireless communication through the wireless transmitter/receiver unit of the communication interface 142 are described in U.S. patent application Ser. No. 12/423,203, entitled “SUPPORTING REMOTE ANALYSIS,” filed Apr. 14, 2009, the entire contents of which are incorporated by reference herein.

Typically, for example, the communication interface 142 permits the processor 134 to communicate with other devices—including other measurement devices 100 and/or computer systems—via a wireless network that includes multiple devices connected to the network, and/or via a direct connection to another device. The processor 134 can establish a secure connection (e.g., an encrypted connection) to one or more devices to ensure that signals can only be transmitted and received by devices that are approved for use on the network.

The processor 134 communicates with a central computer system to update the database of reference information stored in the storage unit 140. The processor 134 is configured to contact the central computer system periodically to receive updated reference information. The processor 134 can additionally or alternatively receive automatic updates that are delivered by the central computer system. The updated reference information can include reference absorption information, for example, and can additionally or alternatively include one or more new or updated lists of prohibited substances.

The processor 134 can also communicate with other measurement devices to broadcast alert messages when certain substances—such as substances that appear on a list of prohibited substances—are identified, for example. Alert messages can also be broadcast to one or more central computer systems. Alert information—including the identity of the substance, the location at which the substance was identified, the quantity of the substance, and other information—can also be recorded and broadcast to other measurement devices and computer systems.

In some embodiments, the measurement device 10 can be connected to other devices over other types of networks, including isolated local area networks and/or cellular telephone networks. The connection can be a wireless connection or a wired connection. Signals, including alert messages, can be transmitted from the processor 134 to a variety of devices such as cellular telephones and other network-enabled devices that can alert personnel in the event that particular substances (e.g., prohibited substances) are detected by the measurement device 10.

Typically, the user interface 232 that includes a control panel that enables a system operator to set configuration options and change operating parameters of the measurement device 10. In some embodiments, the measurement device 10 can additionally or alternatively include an internet-based configuration interface that enables remote adjustment of configuration options and operating parameters. The interface can be accessible via a web browser, for example, over a secured or insecure network connection. The internet-based configuration interface permits remote updating of the measurement device 10 by a central computer system or another device, ensuring that all measurement devices that are operated in a particular location or for a particular purpose have similar configurations. The internet-based interface can also enable reporting of device configurations to a central computer system, for example, and can enable tracking of the location of one or more measurement devices.

The light source 102 includes one or more laser diodes configured to provide infrared light, so that the measurement device 10 functions as an infrared spectrometer. Typically, for example, the infrared light provided by the light source 102 includes a distribution of wavelengths, and a center wavelength of the distribution is about 785 nm. Additionally or alternatively, the light source 102 can include other sources, such as light-emitting diodes and lasers. A center wavelength of the distribution of wavelengths of the light provided by the light source 102 can be 700 nm or more (e.g., 750 nm or more, 800 nm or more, 850 nm or more, 900 nm or more, 950 nm or more, 1000 nm or more, 1050 nm or more, 1100 nm or more, 1150 nm or more, 1200 nm or more, 1300 nm or more, 1400 nm or more).

Typically, an intensity of the light 168 provided by the light source 102 is about 50 mW/mm². In general, however, the intensity of the light 168 can be varied (e.g., via a control signal from the processor 134 transmitted along communication line 162f) according to the particular gas and the sensitivity of the detector 132. In some embodiments, for example, the intensity of the light 168 provided by the source 102 is 10 mW/mm² or more (e.g., 25 mW/mm² or more, 50 mW/mm² or more, 100 mW/mm² or more, 150 mW/mm² or more, 200 mW/mm² or more, 250 mW/mm² or more, 300 mW/mm² or more, 400 mW/mm² or more).

In certain embodiments, the properties of the light 168 provided by the light source 102 can be altered by control signals from the processor 134. For example, the processor 134 can adjust an intensity and/or a spectral distribution of the light 168. The processor 134 can adjust spectral properties of the light 168 by activating one or more filter elements (not shown in FIG. 3), for example. In general, optical assembly 128 can include lenses, mirrors, beamsplitters, filters, and other optical elements that can be used to condition and adjust properties of the light 168.

The detector 132 is configured to measure the reflected light beam 176 after the focusing optics 198 direct the reflected light beam 176 into the optical assembly 128. Typically, the detector 132 includes a pyroelectric detector element that generates an electronic signal, the magnitude of the signal being dependent on an intensity of the reflected light beam 176. In general, however, the detector 132 can include a variety of other detection elements. For example, in some embodiments, the detector 132 can be a photoelectric detector (e.g., a photodiode) that generates an electronic signal with a magnitude that depends on the intensity of the light beam 176.

The light source 144 generates the light beam 178 that is used to measure the position of mirror 110. The light source 144 includes a vertical cavity surface-emitting laser (VCSEL) that generates light having a central wavelength of 850 nm. In general, the light source 144 can include a variety of sources, including laser diodes, light-emitting diodes, and lasers. The light beam 178 can have a central wavelength in an ultraviolet region, a visible region, or an infrared region of the electromagnetic spectrum. For example, in some embodiments, a central wavelength of the light beam 178 is between 400 nm and 1200 nm (e.g., between 400 nm and 500 nm, between 500 nm and 600 nm, between 600 nm and 700 nm, between 700 nm and 800 nm, between 800 nm and 900 nm, between 900 nm and 1000 nm, between 1000 nm and 1100 nm, between 1100 nm and 1200 nm).

The detector 150 can include a variety of different detection elements configured to generate an electronic signal in response to the light beam 184. In some embodiments, for example, the detector 150 includes a pyroelectric detector. In certain embodiments, the detector 150 includes a photoelectric detector, such as a photodiode. Generally, any detection element that generates an electronic signal that is sensitive to changes in an intensity of the light beam 184 can be used in the detector 150.

Further details of the components of the optical assembly 128 is included in United States Patent Application Publication 2008/0291426, entitled “OPTICAL MEASUREMENT OF SAMPLES,” published Nov. 27, 2008, the entire contents of which are incorporated by reference herein.

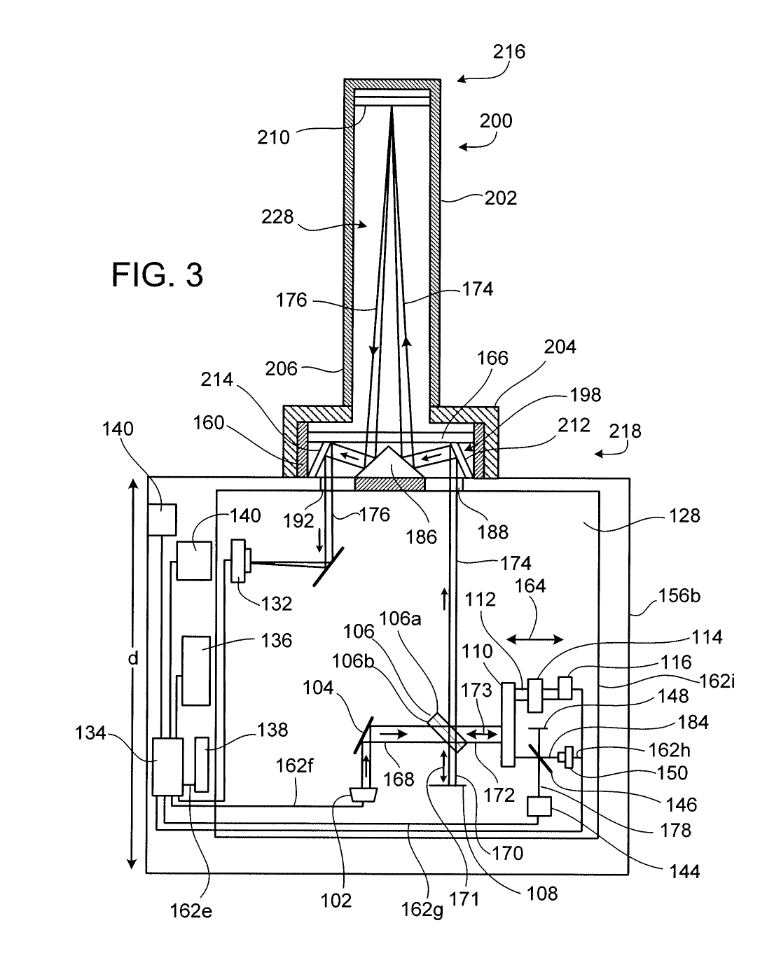

FIG. 4A shows an example of a calibration process 279 performed by the electronic processor 134 of measurement device 10. The electronic processor 134 sends 281 a command to the light source 102 to generate a light signal to be sent from the optical assembly 128 into clean air in the sample volume 228 to be reflected back through the clean air in the sample volume 228 such that the reflected light is received at the detector 132. In some embodiments, the electronic processor 134 sends 281 a command to the light source 102 based on an input received through the user interface 232. In certain embodiments, the electronic processor 134 sends 281 a command to the light source 102 based on a signal received through the communication interface 142. For example, the communication interface 142 can be in communication with a remote server that initiates the calibration process 279 based on knowledge of the position of the measurement device 10 (e.g., as determined by a global positioning system carried on the measurement device 10 or carried by an operator associated with the measurement device 10)

The electronic processor 134 determines 283 the quantity of light absorbed by each optical element in the measurement device 10 and the quantity of light absorbed by the clean air in the sample volume 228. Determinations 283 are made for each optical element along the optical path defined by the light 168, the incident light beam 174, and the reflected light beam 176. For example, the electronic processor 134 determines 283 the quantity of light absorbed as the light 168 from the light source 102 passes through the beam splitter 106.

The light absorbed by the clean air in the sample volume substantially corresponds to light absorbed by CO₂ and H₂O (vapor) that is present in the clean air. The electronic processor 134 can compare the measured absorption spectra of CO₂ and H₂O to stored absorption spectra of each respective species and/or to a stored absorption spectrum of clean air. This comparison can, for example, include determining whether the measured signals from CO₂ and H₂O fall within an acceptable range along a spectral axis (e.g., a spectral axis associated with FTIR analysis).

The electronic processor 134 determines one or more calibration parameters (e.g., constants) based at least in part on the light absorbed by the optical elements. Additionally or alternatively, the electronic processor 134 determines one or more calibration parameters based at least in part on how the measured signals from CO₂ and H₂O must be moved along the spectral axis to fall within an acceptable range, such as a range that is stored by the electronic processor 134.

The electronic processor 134 stores 285 the one or more calibration parameters. In some embodiments, the electronic processor 134 stores 285 each quantity of light absorbed by each optical element in a dynamic array, wherein each address in the array corresponds to a quantity of light absorbed by an optical element of the measurement device 10. In certain embodiments, the electronic processor 134 stores 285 at least some quantities of light absorbed by each optical element in a permanent memory. For example, the quantity of light absorbed by a particular component can be determined during an initial configuration/assembly of the measurement device 10 and stored permanently in a one-time programmable memory in communication with the electronic processor 134, while the quantity of light absorbed by the clean air in the sample volume 228 is stored as part of a dynamic memory in communication with the electronic processor 134.

The electronic processor 134 receives 287 a measurement of light absorbed by gas 60 introduced into the sample volume by placing the measurement device 10 into the gas 60. For example, the measurement device 10 can be placed into a measurement environment such that the gas 60 substantially surrounds the measurement device 10 and at least some of the gas 60 moves into the sample volume 228. The electronic processor 134 can receive a signal from the user interface 232 to indicate that the measurement device 10 is in a measurement mode rather than, for example, a calibration mode. Additionally or alternatively, the electronic processor 134 can determine that the measurement device 10 is in a measurement mode based at least in part on a signal received from a motion sensor carried by the measurement device 10. In some embodiments, the electronic processor 134 determines that the measurement device 10 is in a measurement mode after a specific period of time has elapsed following initiation of the calibration process 279.

The electronic processor 134 constructs 289 a signal indicative of the gas 60 introduced into the sample volume by adjusting the received measurement of light by one or more of the stored calibration parameters. For example, the electronic processor 134 can move the received signal along the spectral axis such that spectra associated with the CO₂ and H₂O constituents of the gas 60 fall along a portion of the spectral axis to fall within an acceptable range on the spectral axis.

FIG. 4B shows an example of a self-test process 280 performed by the measurement device 10 when the tower 200 is disposed in substantially clean air. The self-test process 280 can, for example, provide the system operator with verification that the measurement device 10 remains calibrated, is in a clean environment, and/or is working properly.

In certain embodiments, the system operator places the tower 200 in clean air (e.g., in an open-air environment outdoors). In some embodiments, the user interface 232 can prompt the user to place the tower 200 in clean air. For example, this prompt can be provided to the user after a period of inactivity, during start up, and/or randomly between uses of the device. In some embodiments, the user can be prompted to place the tower in clean air at fixed intervals following a successful calibration.

With the measurement device 10 disposed in clean air, the electronic processor 134 sends 282 instructions to the optical assembly 128 to perform a single sweep of the minor 110. For example, the electronic processor 134 can direct the optical assembly 128 to move the mirror 110 through a single sweep automatically upon start-up and/or in response to an input received from the system operator through the user interface 232.

During the single sweep, the detector 132 detects 284 the light in the reflected beam 176. The light detected by the detector 132 is stored 286, for example, in the storage unit 140. If the sweep is complete 288, the electronic processor 134 forms 290 the interferogram based on the measurement data stored in the storage unit. Until the sweep is complete 288, the process 280 continues to detect 284 light in the reflected beam and store 286 the detected signal until the sweep is complete 288 (e.g., as determined by the electronic processor 134). If the sweep is complete 288, the electronic processor 134 forms 290 the interferogram based on the measurement data stored in the storage unit.

From the formed interferogram, the electronic processor 134 determines 292 whether the features of the reflected beam in the interferogram are accounted for by the light absorbed by one or more of the optical elements of the measurement device 10 and the light absorbed by components of clean air (e.g., CO₂ and H₂O). In some embodiments, the light absorbed by one or more of the optical elements of the measurement device 10 and the light absorbed by components of clean air are determined during the calibration process (e.g., as shown in FIG. 4A).

In general, in a calibrated measurement device 10, the features of the reflected beam are accounted for by the light absorbed by one or more of the optical elements of the measurement device 10 and the light absorbed by components of clean air (e.g., CO₂ and H₂O). Similarly, the features of the reflected beam that are not accounted for by the light absorbed by the one or more optical elements and the light absorbed by components of clean air can be an indication that the measurement device 10 has fallen out of calibration (e.g., through normal system changes that occur over time or through the optical elements becoming dirty and/or damaged). In some embodiments, the degree to which the features of the reflected beam are accounted for is quantified, at least in part, by a signal-to-noise ratio determined from the reflected beam. For example, a calibrated measurement device 10 can have a lower signal-to-noise ratio in clean air than an uncalibrated measurement device 10 in clean air (e.g., the features that are unaccounted for in a clean air measurement can be interpreted by the electronic processor 134 as a signal, resulting in a higher signal-to-noise ratio).

If the electronic processor 134 determines 292 that there is one or more feature of the reflected beam in the interferogram that is not accounted for by the light absorbed by the one or more optical elements and the light absorbed by components of clean air, the electronic processor 134 sends 298 an indication that the self-test failed. The indication can be sent to the user interface 232 and/or to a central server (e.g., by wireless transmission through the communication interface 142).

If the electronic processor 134 determines 292 that the features of the reflected beam in the interferogram is accounted for by the light absorbed by the one or more optical elements and the light absorbed by components of clean air, the electronic processor 134 sends 296 an indication that the self-test was successful. The indication can be sent to the user interface 132 and/or to a central server (e.g., by wireless transmission through the communication interface 142). Additionally or alternatively, following a successful self-test, the electronic processor 134 can prompt the user to perform a subsequent self-test after a fixed period of time.

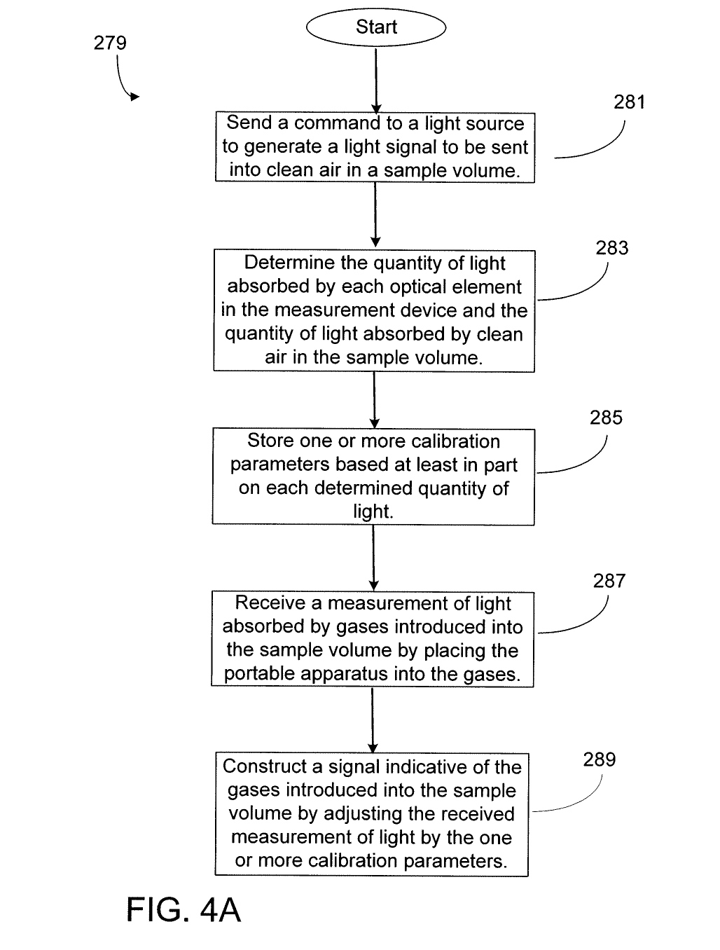

FIG. 5 shows an example of a scanning process 270 performed by the measurement device 10 during measurement of gas occupying the sample volume 228 of the tower 200. The measurement device 10 performs 232 a sweep (e.g., movement of the minor 110 through a range of positions, as described above with respect to FIG. 3) to obtain an interferogram. The measurement device determines 234 whether the obtained interferogram is acceptable.

If the interferogram is not acceptable, the measurement device 10 determines 238 whether the detector 132 is saturated. For example, the measurement device 10 can determine whether the signal at the detector 132 fails to increase as more light strikes the detector 132. In some embodiments, a saturation condition is determined when the detector 132 fails to increase in response to a 5% increase in light to the detector 132.

If the measurement device 10 determines 246 that the detector 132 is saturated, the measurement device 10 instructs 240 a user (e.g., system operator) to move the measurement device away from a source of the gas 60.

If the measurement device 10 determines 246 that the detector 132 is not saturated, the measurement device 10 determines 236 whether the interferogram is suggestive of dirty optics or an obstruction in the sample volume. In some embodiments, the optical throughput of the measurement device 10 is substantially constant, and this value is stored in the storage unit 140. During use, the determination of whether the interferogram is suggestive of dirty optics or an obstruction in the sample volume can be based at least in part on whether a measured optical throughput is less than the stored value of the optical throughput of the system.

If the interferogram is suggestive of dirty optics or an obstruction in the sample volume, the electronic processor 134 instructs 242 the user to clean the tower and/or the sample volume. If the interferogram is not suggestive of dirty optics or an obstruction in the sample volume, the electronic processor 134 can perform 232 a sweep to obtain an interferogram.

If the interferogram is acceptable, the electronic processor 134 determines 244 the intensity of features of the reflected beam that are not accounted for by the optical elements of the measurement device 10 or by clean air. For example, for an acceptable interferogram, the electronic processor 134 can actively ignore the features that correspond to calibration parameters determined during a calibration process (see, e.g., FIG. 4A and associated description).

For a calibrated measurement device 10, features that are not accounted for by the calibration parameters are indicative of the gas 60 being measured. The electronic processor 134 determines 246 whether the intensity of these unaccounted for features is strong enough to perform identification of the gas 60. For example, the electronic processor 134 can include one or more stored threshold values of acceptable intensity such that a measured intensity value above the one or more threshold values can be considered acceptable.

If the determined intensity is strong enough to perform identification, the electronic processor 134 performs 248 of an analysis of the gas 60. The analysis can be, for example, identification of the gas 60 and/or quantification of the concentration of the gas 60.

If the determined intensity is not strong enough to perform identification, the electronic processor 134 performs 232 a sweep to obtain an interferogram. In some embodiments, the electronic processor 134 includes a counter that increments after a threshold number of unacceptable interferograms have been obtained and/or after a threshold number of low intensity features have been measured. The electronic processor 134 can stop performing sweeps and/or send an error message to the user interface 232 when the counter increment exceeds one or more of the threshold values indicative of unsuccessful measurements. Additionally or alternatively, the electronic processor 134 can stop performing sweeps and/or send an error message to the user interface 232 if the time to obtain an acceptable interferogram exceeds a threshold time limit. Such a time threshold can be useful, for example, for reducing the exposure of a system operator to potentially harmful gases.

While certain embodiments have been described, other embodiments are possible.

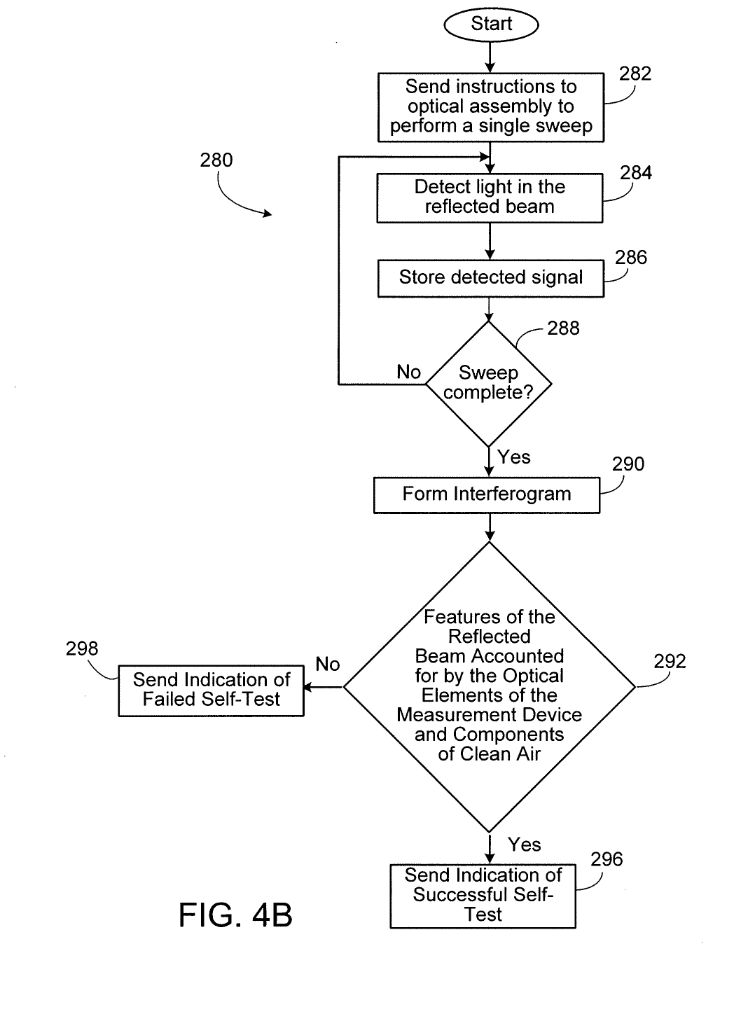

As an example, while the tower 200 has been described as allowing the light beam 74 to pass through the sample volume 228 a single time and, similarly, allowing the reflected beam 76 to pass through the sample volume 228 a single time, other embodiments are possible. In some embodiments, as shown in FIG. 6, a connector 300 supports a window 304 having a reflective coating 302 disposed along a portion of the surface of the window 304 facing the sample volume 228. In use the focusing optics 198 direct a light beam 306 (e.g., a light beam emanating from the base unit 100) into the sample volume 228. The light beam 306 is incident upon the mirror 210 and reflected beam 308 is reflected back toward the window 304. The reflective coating 302 redirects the reflected beam 308 back into the sample volume 228. This pattern of repeated reflections can be repeated several times until the reflected beam 308 passes through the window 304 along a portion of the window that is uncoated by the reflective coating 302. Repeating the pattern of reflections can result in a longer effective optical path through the tower 200 with little to no increase in the size of the tower 200 and/or little to no increase in the overall length of the measurement device 10. Such a longer effective optical path allows for an increased number of interactions between the gas in the sample volume 228 and the light, which can increase the dynamic measurement range of the measurement device 10. Thus, for example, the reflective coating 302 can facilitate identification of lower concentrations of a given component of a gas.

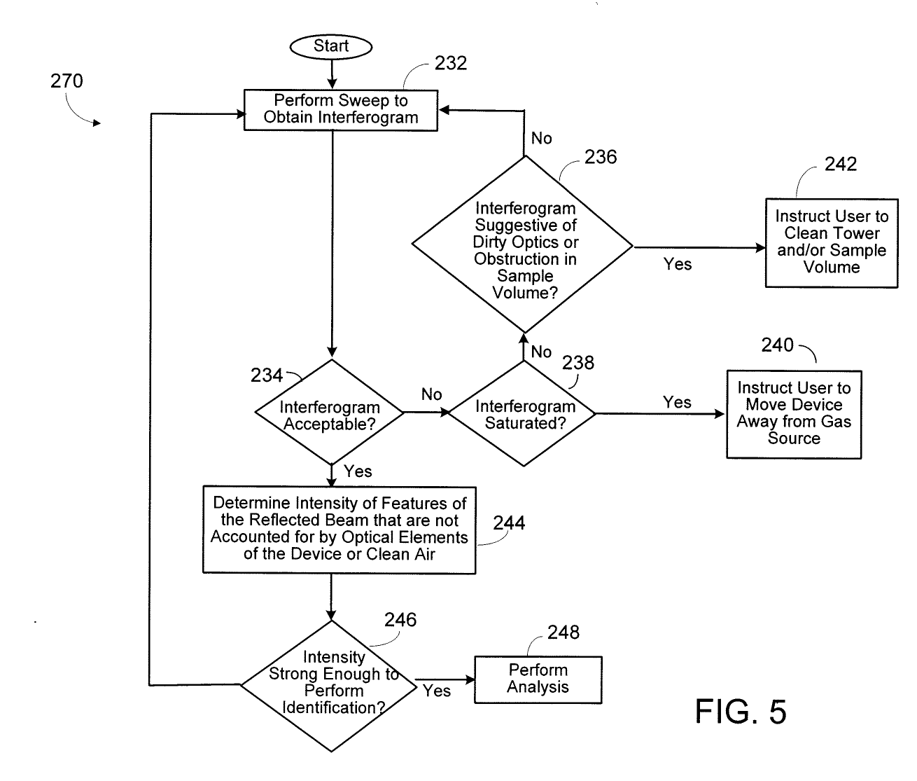

As another example, while the tower 200 has been depicted as an elongate member having a substantially uniform cross-section along its length, other embodiments are possible. In some embodiments, as shown in FIG. 7, a tower 310 can include a first end portion 318 and a second end portion 320, and the tower 310 defining a sample volume 316 extending therebetween. A width dimension of the first end portion 318 is narrower than a width dimension of the second end portion 320 such that the tower 310 and the sample volume 316 each has an overall shape of a tapered cone.

The tower 310 includes a reflective coating 322 disposed along at least a portion of the sidewalls of the tower 310. During use, light 324 from the base unit 100 enters the tower 310 (e.g., through focusing optics 198) and impinges on the sidewalls of the tower 310 as the tower 310 tapers inward from the first end portion 318 to the second end portion 320. The reflective coating 322 on the sidewalls of the tower 310 reflect the light 324 into the sample volume 316, toward another portion of the sidewall of the tower 310. This process can repeat itself along the length of the tower 310, toward the first end 318, such that the light 324 travels the length of the tower 310 in a substantially zigzag pattern. Although not shown in FIG. 7 to facilitate clarity of illustration, light reflected from a mirror 312 supported on the first end 318 of the tower 310 can travel back through the sample volume 316 along a substantially zigzag path. As compared to a substantially linear optical path extending the length of the tower 310, the zigzag optical path is longer. Such a longer optical path can increase the number of interactions between the gas and the light, allowing the dynamic measurement range of the measurement device to increase.

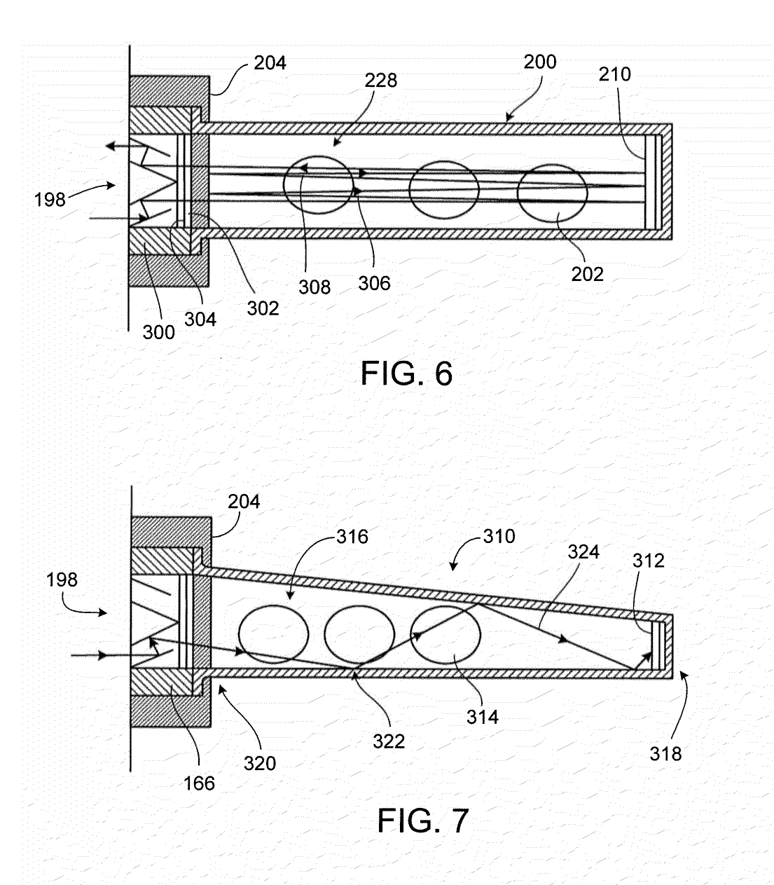

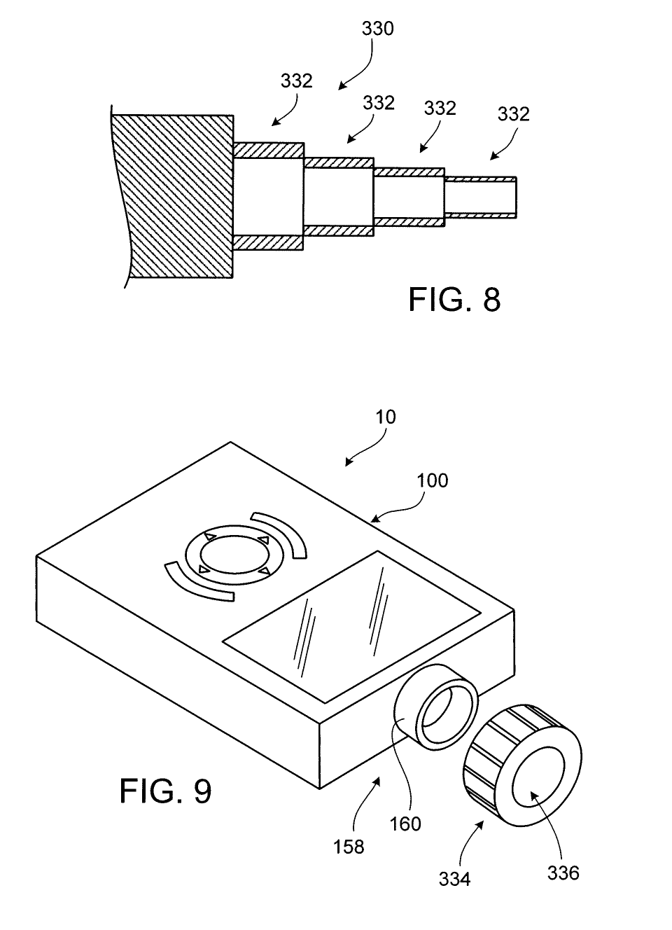

While various embodiments of towers disclosed herein have been depicted as having a substantially fixed length, other embodiments are possible. In certain embodiments, as shown in FIG. 8, the tower 330 includes a plurality of nesting pieces 33, the outside diameter of each nesting piece 33 being substantially equal to the inside diameter of the successive nesting piece 33. The nesting pieces 33 are slidable relative to one another such that the tower 330 is telescopically expandable and/or retractable as required for a given application. For example, to facilitate insertion of the tower 330 into a small volume, at least a portion of the tower 330 can be collapsed. Additionally or alternatively, at least a portion of the tower 330 can be expanded to increase the number of gas interactions between a gas in the tower and a light passing through the gas in the tower. Thus, a system operator can adjust the dynamic range of a measurement device including the tower 330 by moving the nesting pieces 332 relative to one another. This can be useful, for example, to reduce the need for carrying multiple, different towers to achieve a range of dynamic ranges.

While the measurement device has been described as including a base unit 100 and a tower, other embodiments are possible. In certain embodiments, the measurement device 10 includes a collar 334 supporting a prism 336. A face of the prism 336 is substantially exposed at one end of the collar 334 to facilitate optical analysis of solid and/or liquid materials as described, for example, in the '304 patent application incorporated by reference above. In some embodiments, the collar 334 is releasably coupled to the connector portion 166 (e.g., through a threaded connection). For example, the collar 334 can be used to identify a liquid substance and then removed (e.g., unscrewed) from the base unit 100 to allow an interchangeable gas tower to be releasably coupled to the base unit 100 for identification of one or more gases.

While the collars disclosed herein have been described as being fixedly attached to a gas tower, other embodiments are possible. In some embodiments, the collar is part of the base unit (e.g., attached to the protrusion of the base unit) such that the collar remains coupled to the base unit when the gas tower is decoupled from the base unit. This configuration can enable a single collar to be used with multiple different towers which can reduce the overall cost of the system by reducing the number of collars required. In certain embodiments, the collar remains coupled to the base unit while being able to rotate about the protrusion to engage the gas tower. This can facilitate assembly and disassembly of the measurement device in the field.

While the towers described herein include apertures that allow gases outside of the tower and the base unit to pass into the sample volume defined by the tower, other embodiments are possible. For example, the tower can include a gas permeable membrane disposed along at least some of the apertures. Such a gas permeable membrane can reduce the likelihood that foreign matter will enter the sample volume to interfere with an optical measurement by dirtying and/or damaging the optics in the gas tower.

While the communication interface 142 has been described as including a wireless transmitter/receiver unit, other embodiments are possible. In some embodiments, the communication interface 142 includes a standard USB port that can allow the communication interface 142 to connect directly to a computer (e.g., a desktop computer and/or a laptop used for field repair and maintenance). In certain embodiments, the communication interface 142 is in communication with the storage unit 140 such that software updates can be provided to the USB port can be provided to the storage unit 140 via a computer connected to the USB port.

While the optical path length through the sample volume 228 has been described as being manually adjustable (e.g., a system operator can change the path length by changing one tower with another tower having a different optical path length), other embodiments are possible. For example, a measurement device can adjust the optical path length. In some embodiments, a repositionable mirror supported along an end portion of the sample volume 228 can be coupled to a motor configured to move the mirror to change the optical path length. In certain embodiments, the repositionable mirror is supported on one or more rails that extend lengthwise along the tower such that actuation of the motor can move the mirror along the rails, in a direction toward the base unit 100. The motor can move the mirror in response to commands received by a system operator. Additionally or alternatively, the motor can move the mirror in response to a detected signal. For example, the motor can move the mirror toward the base unit 100 to shorten the optical path length if the detector 132 is saturated by the signal reflected through the sample volume 228.

While the optical assembly 128 has been described as measuring the amount of incident light absorbed by gas in the sample volume, other embodiments are possible. For example, an optical assembly can measure one or more of the following: the amount of light scattered in the sample volume, the emission of light in the sample volume, and/or total intensity of light.

While the electronic processor 134 has been described as identifying the composition of the gas 60 in the sample volume 228, other embodiments are possible. For example, an electronic processor can quantify the concentration of a gas in the sample volume 228. In some embodiments, the electronic processor determines the concentration of the gas based at least in part on the total intensity of the light measured by the optical assembly 128.

The measurement devices disclosed herein can be used for a variety of sample identification applications. For example, the measurement devices disclosed herein can be used in airports and other transportation hubs, in government buildings, and in other public places to identify unknown (and possibly suspicious) substances, and to detect hazardous and/or prohibited substances. Airports, in particular, restrict a variety of substances from being carried aboard airplanes. The measurement devices disclosed herein can be used to identify substances that are discovered through routine screening of luggage, for example. Identified substances can be compared against a list of prohibited substances (e.g., a list maintained by a security authority such as the Transportation Safety Administration) to determine whether confiscation and/or further scrutiny by security officers is warranted.

Law enforcement officers can also use the portable measurement devices disclosed herein to identify unknown substances, including illegal substances such as narcotics. Accurate identifications can be performed in the field by on-duty officers.

The measurement systems disclosed herein can also be used to identify a variety of industrial and pharmaceutical substances. Shipments of chemicals and other industrial materials can be quickly identified and/or confirmed on piers and loading docks, prior to further transport and/or use of the materials. Further, unknown materials can be identified to determine whether special handling precautions are necessary (for example, if the materials are identified as being hazardous). Pharmaceutical compounds and their precursors can be identified and/or confirmed prior to production use and/or sale on the market.

Generally, a wide variety of different samples can be identified using the measurement devices disclosed herein, including pharmaceutical compounds (and precursors thereof), narcotics, industrial compounds, explosives, energetic materials (e.g., TNT, RDX, HDX, and derivatives of these compounds), chemical weapons (and portions thereof), household products, plastics, powders, solvents (e.g., alcohols, acetone), nerve agents (e.g., soman), oils, fuels, pesticides, peroxides, beverages, toiletry items, other substances (e.g., flammables) that may pose a safety threat in public and/or secure locations, and other prohibited and/or controlled substances.

Other embodiments are in the claims.

What is claimed is:

1. A portable device comprising:
a base unit comprising a light source, a light detector, and at least one window through which light exits from, and is received by, the base unit;
an extension configured, during use, to be attached to the base unit and to extend from the at least one window, in a direction away from the base unit, the extension defining at least a portion of a sample volume in fluid communication with gases substantially surrounding one or more of the extension and the base unit; and
a mirror attached to the extension at a distance from the at least one window, an optical path defined between the mirror and the at least one window such that light from the light source moves through the sample volume along the optical path, and the mirror aligned to reflect the light back to the at least one window for detection by the light detector.

2. The portable device of claim 1 in which the base unit and the extension are positionable in fluid communication with gases substantially surrounding the extension and the base unit during measurement of the gases.

3. The portable device of claim 1 in which the distance between the mirror and the at least one window is less than 50 cm.

4. The portable device of claim 1 in which the light from the light source comprises infrared light.

5. The portable device of claim 1 in which the base unit is a component of a Fourier transform infrared spectrometer for gases along the optical path.

6. The portable device of claim 1 in which the base unit has a handheld form factor.

7. The portable device of claim 1 in which the window is partially reflective to define an optical cavity between the window and the mirror so that the light from the light source is reflected along the optical path multiple times.

8. The portable device of claim 1 in which the extension comprises one or more walls, at least one of the walls defining one or more openings, and wherein the gases substantially surrounding one or more of the extension and the base unit are in fluid communication with the sample volume through the one or more openings.

9. The portable device of claim 1 in which the extension comprises one or more gas permeable membranes through which at least some gases substantially surrounding one or more of the extension and base unit are in fluid communication with the sample volume.

10. The portable device of claim 1 further comprising an electronic processor in communication with the light detector and configured to determine information about gases in the sample volume based at least in part on the measurements made by the light detector.

11. The portable device of claim 10, wherein the electronic processor is coupled to the light detector in the base unit.

12. The portable device of claim 10, wherein the information determined by the electronic processor comprises an identification of one or more constituents of the gases in the sample volume.

13. The portable device of claim 10, wherein the information determined by the electronic processor comprises a verification of an identity of one or more constituents of the gases in the interior volume.

14. The portable device of claim 10, wherein the electronic processor is further configured to store reference data and to compare the stored reference data to the information determined by the electronic processor.

15. The portable device of claim 1 in which the base unit further comprises a user interface for presenting information determined from measurements by the light detector to a user.

16. The portable device of claim 1 further comprising circuitry for wirelessly transmitting information determined from measurements by the light detector to a remote location.

17. The portable device of claim 1, wherein the portable device weighs less than 2 kg.

18. The portable device of claim 1, wherein gas pressure in the sample volume is substantially equal to the gas pressure of the gases substantially surrounding one or more of the extension and the base unit.

19. The portable device of claim 1, wherein the distance between the mirror and the at least one window is adjustable to change a length of the optical path in the sample volume.

20. The portable device of claim 1, further comprising an electronic processor and a user interface, the electronic processor in communication with each of the light detector and the user interface, the electronic processor configured to send to the user interface an indication of a signal-to-noise ratio of a signal measured and the noise detected at the light detector.

21. The portable device of claim 1, wherein the extension is releasably attachable to the base unit.

22. The portable device of claim 21, wherein the base unit is configured to support focusing optics along an optical path between the light source and the sample volume such that the focusing optics direct light into the sample volume and direct reflected light from the sample volume toward the light detector.

23. The portable device of claim 22, wherein the base unit is further configured to support releasably a prism, interchangeably with the focusing optics, such that a surface of the prism contacts a solid or a liquid sample while the prism is coupled to the base unit.

24. The portable device of claim 1, wherein the light source and the light detector are substantially sealed from fluid communication with the sample volume.

25. The portable device of claim 1, wherein the extension comprises a material selected from anodized aluminum, coated metal, stainless steel, and plastic.

26. The portable device of claim 1, wherein a combined length of the extension attached to the base unit is less than about 50 cm.

27. The portable device of claim 1, wherein the extension is integrally formed with the base unit.

28. The portable device of claim 1, wherein the extension is hollow.

29. The portable device of claim 1, wherein the base unit is portable.

30. The portable device of claim 1, further comprising electronic circuitry configured to
determine a quantity of light absorbed by at least one optical element along the optical path and by clean air occupying the sample volume,
store one or more calibration parameters based at least in part on the determined quantity of light,
receive a measurement of light absorbed by the gases in fluid communication with at least a portion of the sample volume; and
construct a signal indicative of the gases in fluid communication with at least a portion of the sample volume by adjusting the received measurement of light by the one or more calibration parameters.

31. The portable device of claim 30, wherein the electronic circuitry is further configured to determine whether features of a beam reflected through clean air occupying at least a portion of the sample volume can be accounted for by the quantity of light absorbed by at least one optical element in a portable apparatus and by clean air in a sample volume of the portable apparatus.

32. The portable device of claim 31, wherein the electronic circuitry is further configured to send an indication of calibration to a user interface, the indication based at least in part on the determination of whether features of the beam reflected through clean air occupying at least a portion of the sample volume can be accounted for by the quantity of light absorbed by at least one optical element in a portable apparatus and by clean air in a sample volume of the portable apparatus.

33. A method comprising:
positioning a portable apparatus to expose a sample volume of the portable apparatus to gases substantially surrounding the portable apparatus, wherein the sample volume is in fluid communication with the gases substantially surrounding the portable apparatus and wherein the portable apparatus comprises a light source and a mirror, the light source and the mirror arranged relative to one another to define an optical path, through the sample volume, for light produced by the light source; and
measuring the light after at least one pass along the optical path to determine information about the gases.

34. The method of claim 33, wherein gas pressure in the sample volume is substantially equal to the gas pressure of the gases substantially surrounding the portable device.

35. The method of claim 33, wherein the sample volume is exposed to gases in a headspace of a container.

36. The method of claim 35, wherein the container comprises solid or liquid material that produces a vapor pressure in the headspace of the container.

37. The method of claim 33, wherein determining information about the gases comprises identifying one or more constituents of the gases in the sample volume.

38. The method of claim 33, further comprising comparing the information determined about the gases to reference data stored by the portable device.

39. The method of claim 38, further comprising verifying the identity of one or more constituents of the gases in the sample volume, the verification based at least in part on a comparison between the reference data and the determined information.

40. The method of claim 39, further comprising sending an alarm to a user interface of the portable device based at least in part on the verification.

41. The method of claim 33, further comprising detecting saturation of a sensor based at least in part on the measurement of the light.

42. The method of claim 33, further comprising sending instructions to a user to move the portable apparatus during the measurement of the light.

43. The method of claim 33 further comprising
determining a quantity of light absorbed by at least one optical element in a portable apparatus and by clean air in a sample volume of the portable apparatus;
storing one or more calibration parameters based at least in part on each determined quantity of light;
placing the portable apparatus into the gases such that the gases occupy at least a portion of the sample volume;
receiving a measurement of light absorbed by the gases occupying at least a portion of the sample volume; and
constructing a signal indicative of the gases occupying at least a portion of the sample volume by adjusting the received measurement of light by the one or more calibration parameters.

44. The method of claim 43, further comprising determining whether features of a beam reflected through clean air occupying at least a portion of the sample volume can be accounted for by the quantity of light absorbed by at least one optical element in a portable apparatus and by clean air in a sample volume of the portable apparatus.

45. The method of claim 44, further comprising sending an indication of calibration to a user interface, the indication based at least in part on the determination of whether features of the beam reflected through clean air occupying at least a portion of the sample volume can be accounted for by the quantity of light absorbed by at least one optical element in a portable apparatus and by clean air in a sample volume of the portable apparatus.
